(19) United States
(12) Patent Application Publication
(10) Pub. No.: US 2016/0291668 A1
(43) Pub. Date: Oct. 6, 2016

(54) Charging Stand having Selectively Interruptible Charging System

(71) Applicant: Leonard J. DiSanza, Austin, TX (US)

(72) Inventor: Leonard J. DiSanza, Austin, TX (US)

(21) Appl. No.: 14/676,597

(22) Filed: Apr. 1, 2015

(51) Int. Cl. G06F 1/32; G06F 3/01; H02J 7/00

(52) U.S. Cl. CPC G06F 1/3203; H02J 7/0047; G06F 3/017

(57) ABSTRACT

A wave charging stand adapted selectively to interrupt charging of a smartphone to initiate a time display function. The stand employs one or more IR sensors to detect a predetermined sequence of wave activation events, e.g., motions or actions of a user's hand adjacent a portion of the stand. To minimize false triggering, valid wave activation events comprise multiple, time-sequenced wave actions. One or more LEDs may be selectively illuminated.

### BACKGROUND OF THE INVENTION

1. Field of the Invention

The present invention relates generally to USB-based charging systems for battery-powered appliances and the like, and, in particular, to a selectively interruptible charging system and method of operation.

2. Description of the Related Art

In general, in the descriptions that follow, I will italicize the first occurrence of each special term of art which should be familiar to those skilled in the art of battery-powered appliance charging systems, especially those adapted to use the Universal Serial Bus (USB). In addition, when I first introduce a term that I believe to be new or that I will use in a context that I believe to be new, I will bold the term and provide the definition that I intend to apply to that term. In addition, throughout this description, I will sometimes use the terms assert and negate when referring to the rendering of a signal, signal flag, status bit, or similar apparatus into its logically true or logically false state, respectively, and the term toggle to indicate the logical inversion of a signal from one logical state to the other. Alternatively, I may refer to the mutually exclusive boolean states as logic_0 and logic_1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

It is widely known that for smartphones which utilize certain operating systems (OSs), e.g., the Android OS or the Apple iOS, that if the USB charge cycle is either initiated or interrupted for a brief amount of time (on the order of at least 250 milliseconds) and the device is “on” but in “sleep” mode it will temporarily “awaken” and display the time. This time-display mode of operation is also available on many tablets utilizing these same OSs. For convenience of reference, I shall hereinafter refer to any device that implements this time-display mode as a time-display mode device or, sometimes, simply as a TDM.

Various electronic devices have been adapted to detect activation of an infrared optical sensor in response to movement of, e.g., a human hand or body portion. Since TDMs are most frequently charged during nighttime hours, the use of an optical sensor based system is preferred over other types of activation; for example, in a sound based system, the activation sound, e.g., voice command or hand clap, will likely result in the disturbance of other people that might be sleeping in the vicinity of the TDM. Other prior art methods require the user to manually activate devices such as mechanical or electrical transmitters or reflectors of various kinds to activate the time-display mode of operation.

As is known, infrared sensors, both passive (“PIR”) and active, are subject to false triggers which, if frequent, would render their use unacceptable in some applications. The primary causes of undesired but physically legitimate triggers include:
1. The viewing angle of the sensor (both PIR and active) is made intentionally to form a very wide semi-hemi-spherical optical pattern, often resulting in unrelated human and pet movement easily “tripping” the sensor; and
2. Most sensor modules are intentionally designed for long range sensing on the order of 15 to 20 feet (FIR only), which, again, can cause undesired triggers from humans and pets.
   Primary causes of unintentional random noise triggers include:
1. Most PIR modules are very high gain systems, on the order of greater than 80 dB, and are always teetering “on the edge” of triggering;
2. Environmental temperature shifts due to air movement can falsely trip PIR sensors;
3. High electric fields and static discharges, known as ESD events, can also cause false triggers;
4. Nuclear particles (alpha, beta, etc.) and even random telegraph signaling noise in long-time-constant DC-coupled systems can lead to bad behavior; and
5. Electrical power supply fluctuations can trip passive or active sensors.
   Known techniques to reduce both types of false triggering include:
1. Limit the optical viewing range by physical infrared blocking;
2. Reduce the system gain to restrict the optical trigger range to 2 to 3 feet;
3. Change the trigger plane (angle), e.g., by moving from the horizontal towards the vertical;
4. Require multiple triggers within a set time frame (use time-qualified triggering) to greatly statistically reduce random triggers;
5. Use multiple PIR sensors and require all to trigger (use AND-logic-qualified triggering) within given time frame;
6. Allow for large power supply capacitance/regulation to reduce supply fluctuation; and
7. Use an active IR source to increase the IR energy received at the detector allowing for the reduction of overall system gain.

I submit that what is needed is an interruptible charging system adapted to selectively activate the time-display mode of operation of a TDM. In particular, I submit that such a system should provide performance generally comparable to the best prior art techniques but more efficiently and effectively than known implementations of such prior art techniques.

### BRIEF SUMMARY OF THE INVENTION

In accordance with a preferred embodiment of my invention, . . .

### BRIEF DESCRIPTION OF THE SEVERAL VIEWS OF THE DRAWINGS

My invention may be more fully understood by a description of certain preferred embodiments in conjunction with the attached drawings in which:

FIG. 1 illustrates, in perspective view, a wave charging stand constructed in accordance with my invention;

FIG. 2 illustrates a side plan view of the stand of FIG. 1;

FIG. 3 illustrates a top plan view of the stand of FIG. 1 with the cover panel removed;

FIG. 4 illustrates, in block diagram form, one instantiation of a control system suitable for implementing my invention;

FIG. 5 illustrates, in flow diagram form, one instantiation of a method for implementing the control system of FIG. 4;

FIG. 6 illustrates, in flow diagram form, a method for validating a wave actuation sequence in a single sensor embodiment of the system of FIG. 4;

FIG. 7 illustrates, in flow diagram form, a method for validating a wave actuation sequence in the dual sensor embodiment of the system of FIG. 4;

FIG. 8 illustrates, by way of example, a passive IR sensor and associated interface and control circuitry suitable for use with my invention; and

FIG. 9 illustrates, by way of example, an active IR sensor and associated interface and control circuitry suitable for use with my invention.

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

My wave stand charging stand is adapted to take advantage of the known time-display mode of operation of certain battery-powered, electronic appliances, e.g., smartphones, tablets or the like (collectively, TDMs). In accordance with my invention, I employ one or more infrared sensors to sense human hand or body movement. My choice of an optical sensor based system over other types of activation such as light or sound is not arbitrary. To better appreciate this choice, assume that the primary usage of my charging stand is when the user (and others in the room such as a partner) is (are) sleeping. Under such circumstances, activation and usage of this device should minimize the disturbance to other person(s) that might be sleeping in the vicinity. Clearly, the use of audible sounds such as clapping or voice should not be used to activate my charging stand. Also, in a normally darkened room, requiring activation by direct touch will may result in the TDM being dropped, and, possibly, damaged. With both sound and touch precluded, I chose hand/body movement detected by infrared optical sensing over such other forms of activation. In addition, I also decided not to require the user to wear any devices such as mechanical or electrical transmitters or reflectors of any kind. For all of these reasons, I selected the time-proven infrared sensing technology as the best fit.

My wave charging stand can easily be adapted to work with either one or more of two types of infrared sensor systems: passive infrared (known heretofore as PIR); or active assisted infrared. At the present time, integrated circuit forms of such infrared sensors are commercially available as die, packaged parts, or in conjunction with other electronics in the form of modules, and any and all implementations can be used with my charging control system.

In normal operation, while a TDM is being charged, the user may, on command, easily invoke the display of time and/or illumination of a modest light without waking a partner. My touch-less wave activation method tends to reduce the risk of a drowsy user damaging the TDM by inadvertently knocking it on the floor.

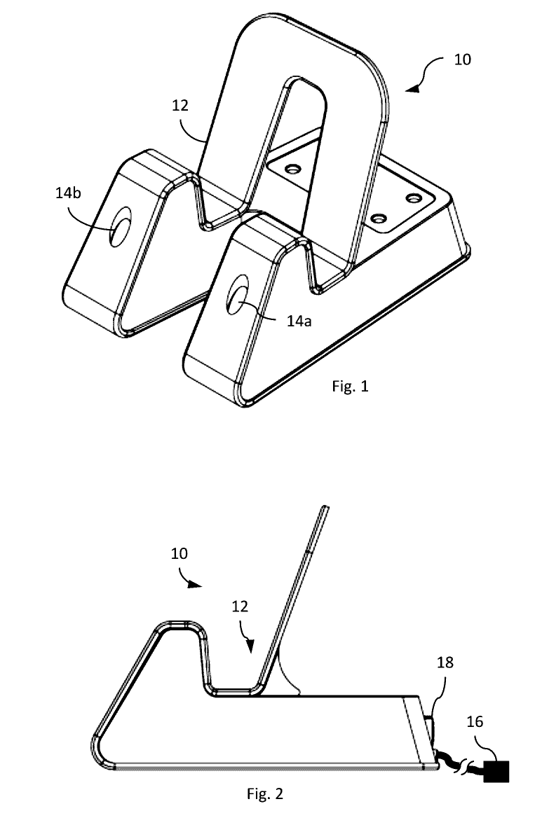

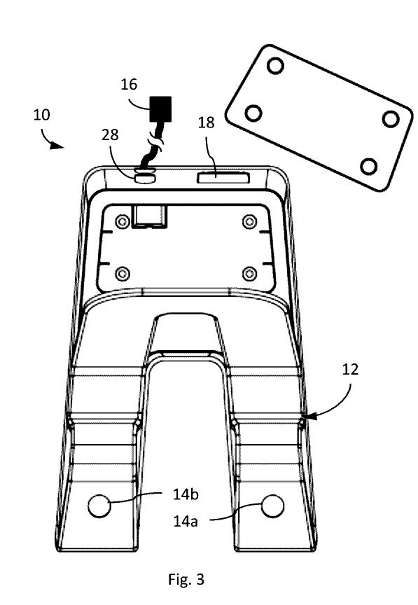

Shown in FIG. 1, FIG. 2 and FIG. 3 is a wave charging stand 10 constructed in accordance with my embodiment. In this embodiment, I have provided a cradle 12 adapted to receive a TDM, e.g., a smartphone or tablet (not shown) for charging. Generally in front of, and below, the cradle 12, I have positioned a first PIR sensor 14a and an optional second PIR sensor 14b, both adapted to view generally upwardly. As shown generally in FIG. 2 and FIG. 3, I provide power to my charging stand 10 via a male USB plug 16 adapted to be connected to a USB-based power source (not shown). I also provide a female USB socket 18 adapted to receive the male-terminated USB cable (not shown) from the appliance when being charged.

In general, my wave charging stand 10 is adapted to provide a safe physical place to hold and charge most any USB-capable TDM (HTC, Motorola, Samsung, Apple, etc.). My device 10 requires no vendor specific proprietary connectors, and the only hard physical connection is the charge cable/plug 16 used to connect the stand 10 to the TDM vendor-supplied and approved charger or other USB power sources (such as a computer) for all power.

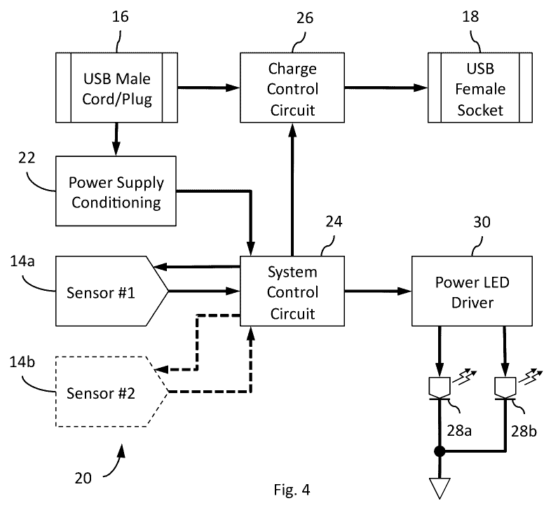

Shown by way of example in FIG. 4 is one embodiment of a control system 20 adapted to control my charging stand 10 in accordance with my invention. In system 20, a power supply conditioning circuit 22 is adapted to develop local operating power upon connection of the plug 16 to an external source of power (not shown). My system control circuit 24 receives sensory signals from one or more sensors 14 and controls the flow of charging current from the plug 16 to socket 18 via a charge control circuit 26. Depending on a mode of operation, system control circuit 24 may selectively illuminate one or more LEDs 28 (e.g., 28a-28b) via a power LED driver circuit 30. In one embodiment, I instantiate the primary functionality of my system control circuit 24 in the form of a programmable microcontroller such as the 8-bit Atmel ATtiny25/V, commercially available from the Atmel Corporation (San Jose, Calif., USA). Of course, practitioners in this art will realize that other embodiments are possible, including, e.g., a programmable logic device (“PLD”) or an application specific integrated circuit (“ASIC”) or other commercially available microcontrollers.

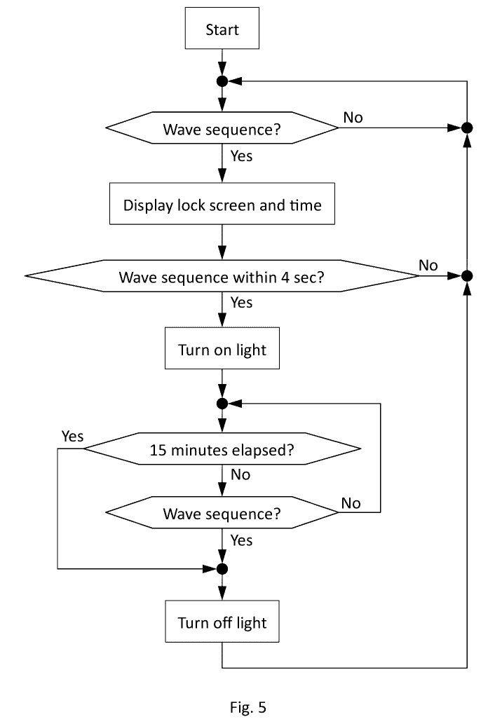

By way of example, I have depicted in FIG. 5 one control flow suitable for implementing my invention using system control circuit 24. In general, the flow loops continuously waiting for a particular sequence of triggers from the sensor(s) 14. In the illustrated flow, the primary function from the perspective of the user is to turn on the time display of the appliance, and a secondary function is to turn on LED(s) 28 to provide local scene illumination.

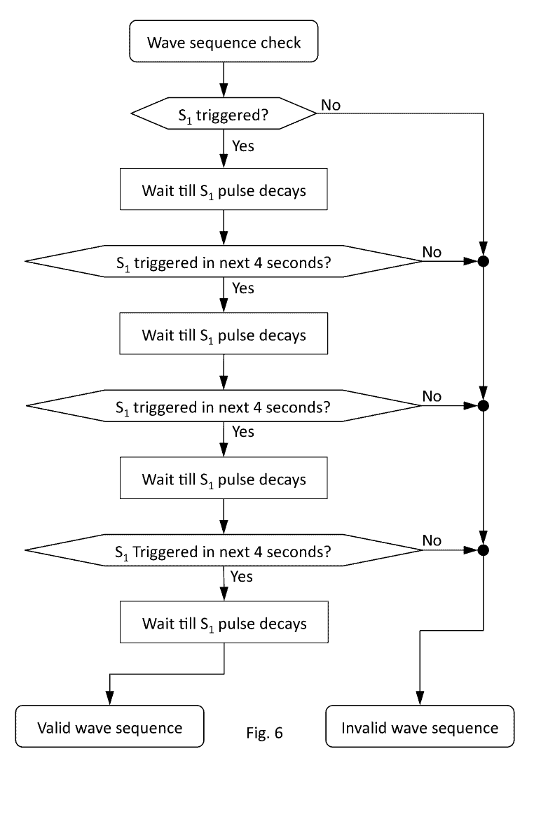

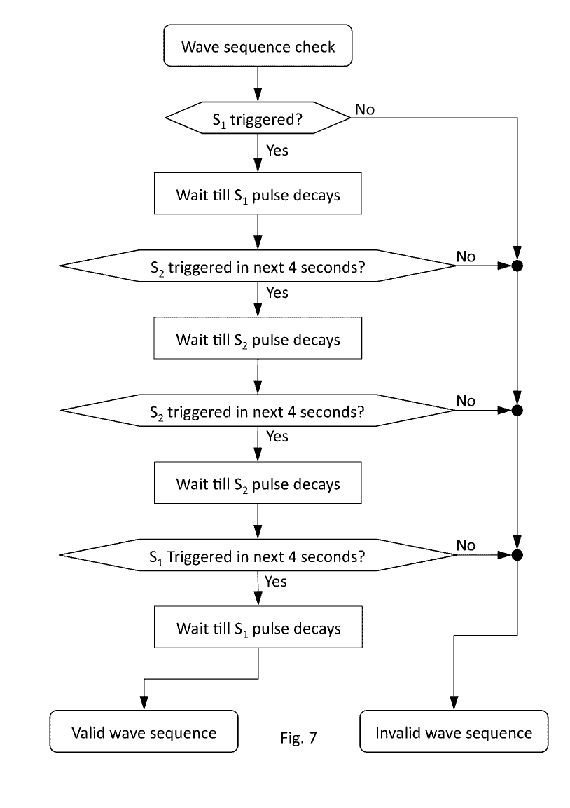

Recall from above that false triggers can not be totally prevented. However, through the judicious use of a number of the deterrents I have listed above, I submit that false triggering can be made statistically insignificant. Thus, my approach is to utilize a combination of different deterrent techniques to reduce false triggers:
1. In my charging stand 10, I impose optical limits on the viewing angle of each sensor 14 by recessing the sensor 14 into the surrounding housing. I also rotate the viewing angle from the typical horizontal position, e.g., wall mounted motion sensors, to a more vertical orientation.
2. In a single sensor embodiment of the system illustrated in FIG. 4, I require multiple triggering actions of the single sensor S₁ to be properly sequenced in time to statistically reduce the chance of false activation. In particular, as illustrated in the flow diagram of FIG. 6, I minimize the likelihood of a random or otherwise unintentional activation since two timing-specific successive wave actions must occur. Note that the second wave action must occur within a trigger window immediately following the decay of the sensor pulse resulting from of the first wave action; I have found a trigger window duration on the order of about 4 seconds to provide an acceptable level of false triggering. As is known, typical PIR sensors are capable of retriggering. To prevent two random, closely-time-separated noise events from causing false activation, my logic is adapted to restart the respective action timer if the sensor S₁ is retriggered before the initial trigger pulse has sufficiently decayed. Actions that may be detected outside the trigger window will not be considered as legitimate components of a wave activation event. Thus, as can be seen in FIG. 6, four (4) separate and distinct hand wave actions must be detected by the single sensor S₁, each within a predetermined period of time of an earlier detected action, before a wave activation event is signaled. In some embodiments, it may be desirable to require a second, independent sequence of this or similar form before a wave activation event is signaled.
3. Also, in my single sensor system, I use a lower system gain as a further deterrent to false activation. For example, I can reduce the trip distance to three or four feet by lowering the gain accordingly. If an even shorter trip range (1.5 feet or less) is acceptable then an active infrared sensor system (such as the Silicon Labs Si1102 optical proximity detector module, commercially available from Silicon Labs, Austin, Tex., USA) can be used in place of a simple PIR device. This shorter trip range may be acceptable in a lower cost version of the device. The advantage of either single sensor system is in its' simplicity and that it has both a lower bill of material (“BOM”) cost and a lower test cost than a dual sensor system. However, a single PIR sensor system does have the disadvantage that the minimum time for two wave activation is at least 1.5 seconds apart and realistically is probably more likely to be at least 2 seconds (although may be possible to reduce the minimum time to at least some extent without increasing the risk of false activation).
4. In a dual sensor embodiment of the system illustrated in FIG. 4, I use two electrically-, physically-, and optically-separated sensors, S₁ and S₂. For proper operation, I require that both sensors must be wave activated before the minimum ON time of either sensor expires. Since I have carefully isolated sensor S₁ from sensor S₂, only double wave actions that effect both in a specific sequence will constitute a legitimate wave activation event. In this manner random noise or random actions will be unlikely to conform to the required timing and sequence. Thus, as can be seen in FIG. 7, four (4) separate and distinct hand wave actions must be detected, each within a predetermined period of time of an earlier detected action, before a wave activation event is signaled. In some embodiments, it may be desirable to require a second, independent sequence of this or similar form before a wave activation event is signaled.

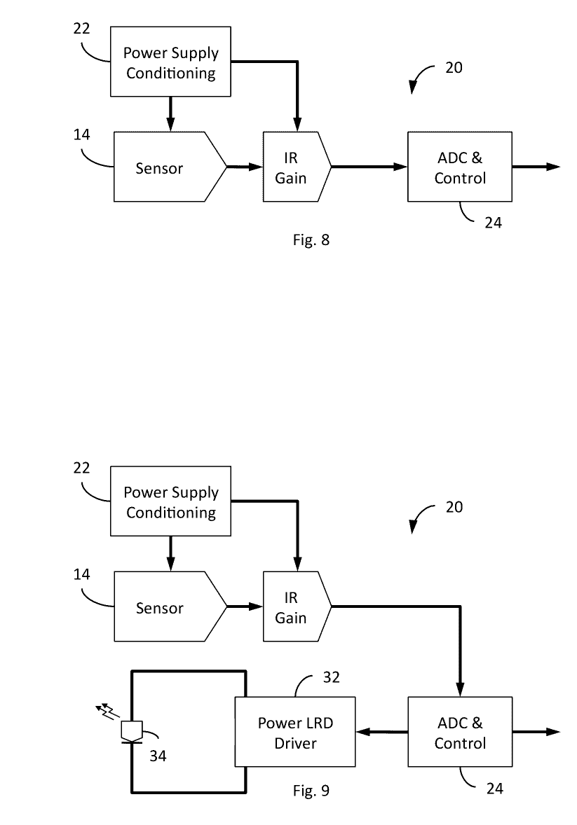

As I have noted, above, either passive or active sensors can be employed with only operational range, availability, and cost determining which should be used. By way of example, I have illustrated a typical passive IR sensor in FIG. 8, and a typical active IR sensor in FIG. 9. As will be recognized by those active in this art, the output power of active IR emitters (see, e.g., FIG. 9) may require compliance with legally established regulations and controls.

In general, my wave charging stand 10 is adapted to activate the time display operation of a TDM in response to appropriate hand wave motion. In the case of my single sensor system, four (4) hand waves, e.g., first from left-to-right then from right-to-left (or vice-versa) followed by one repetition of this sequence, are required during the proper time windows to activate the display; in contrast, in the dual sensor embodiment, only two (2), properly timed hand waves are sufficient to activate the display. In either embodiment, a repetition of the appropriate hand wave activation sequence within a brief time window can also turn on a safety light. This light can be used during the night to locate the phone, glasses, medicine, or even provide a guiding light back to bed from the bathroom. I recommend blue safety LEDs 28 that are “sleeping partner friendly”, and “night vision friendly”. In accordance with my invention, the LEDs can be deactivated either by an additional wave activation, or by simply allowing the internal light timer, e.g., 15 minutes, to time-out (see, FIG. 5).

My wave charging stand 10 is micro-powered when operating in the “lights off” state, consuming only a tiny amount of power above what is otherwise required to charge the TDM. As noted above, all power to charge the TDM and to run all of the control circuits is derived from the USB cable/plug 16.

Although I have described my invention in the context of particular embodiments, one of ordinary skill in this art will readily realize that many modifications may be made in such embodiments to adapt either to specific implementations. By way of example, it will take but little effort to adapt my invention for use with electronic appliances other than contemporary smartphones or tablets; and to adjust the dimensions of the appliance accommodation cradle accordingly. Further, the several elements described above may be implemented using any of the various known manufacturing methodologies, and, in general, be adapted so as to be operable under either hardware or software control or some combination thereof, as is known in this art.

Thus it is apparent that I have provided an interruptible charging system adapted to selectively activate the time-display mode of operation of a TDM. In particular, I submit that such a method and apparatus provides performance generally comparable to the best prior art techniques but more efficiently and effectively than known implementations of such prior art techniques.

What I claim is:

1. A method for use with a battery-operated device having a time display mode of operation activated by an interruption of a connection of the device to a charge source, the method comprising the steps of:
[1] detecting a connection to the charge source;
[2] detecting a connection to the device;
[3] connecting the charge source to the device;
[4] detecting a predetermined activation event; and
[5] upon detecting the activation event, interrupting, for a predetermined period of time, the connection of the charge source to the device;
whereby the time display mode of operation of the device is activated.

2. The method of claim 1 wherein step 4 further comprises the steps of:
[4.1] detecting a first wave event; and
[4.2] detecting a second wave event within a predetermined period of time of detecting the first wave event.

3. The method of claim 2 wherein, in step 4.1, the first wave event comprises a first wave of a hand of a user.

4. The method of claim 3 wherein, in step 4.2, the second wave event comprises a second wave of the hand of the user.

5. The method of claim 2 wherein step 4.1 is further characterized as detecting, using a first motion sensor, a first wave of a hand of a user.

6. The method of claim 3 wherein step 4.2 is further characterized as detecting, using the first sensor, a second wave of the hand of the user.

7. The method of claim 3 wherein detection of the second wave event is further characterized as detecting, using a second motion sensor, a second wave of the hand of the user.

8. The method of claim 2 wherein step 4.1 further comprises the steps of:
[4.1.1] detecting a first wave action; and
[4.1.2] detecting a second wave action within a predetermined period of time of detecting the first wave action.

9. The method of claim 8 wherein:
step 4.1.1 is further characterized as detecting, using a first motion sensor, a first wave of a hand of a user; and
step 4.1.2 is further characterized as detecting, using a second motion sensor, the first wave of the hand of the user.

10. The method of claim 9 wherein:
step 4.2.1 is further characterized as detecting, using the second sensor, a second wave of a hand of a user; and
step 4.2.2 is further characterized as detecting, using the first sensor, the second wave of the hand of the user.

11. The method of claim 8 wherein:
step 4.1.1 is further characterized as detecting, using a first motion sensor, a first wave of a hand of a user; and
step 4.1.2 is further characterized as detecting, using the first sensor, a second wave of the hand of the user;
step 4.2.1 is further characterized as detecting, using the first sensor, a third wave of a hand of a user; and
step 4.2.2 is further characterized as detecting, using the first sensor, a fourth wave of the hand of the user.

12. The method of any of claim 5, 6, 7, 9 10 or 11 wherein each sensor comprises a respective passive infra-red sensor.

13. The method of any of claim 5, 6, 7, 9 10 or 11 wherein each sensor comprises a respective active infra-red sensor.

14. The method of claim 1 further comprising the step of:
[6] upon detecting the activation event, illuminating, for a predetermined period of time, a light source.

15. A charging system configured to perform the method of any preceding claim.

16. A computer readable medium including executable instructions which, when executed in a processing system, cause the processing system to perform all the steps of a method according to any one of the claims 1 to 14.
